(19) United States
(12) Patent Application Publication
(10) Pub. No.: US 2001/0045978 A1
(43) Pub. Date: Nov. 29, 2001

(54) Portable personal wireless interactive video device and method of using the same

(76) Inventors: Daniel L. McConnell, Longwood, FL (US); Thomas G. Smith, Titusvillle, FL (US); Thomas Golden, Lake Mary, FL (US); Thomas D. Laing, Sanford, FL (US)

Correspondence Address: HOLLAND & KNIGHT LLP, PO BOX 1526, ORLANDO, FL, 32802-1526, US

(21) Appl. No.: 09/832,718

(22) Filed: Apr. 11, 2001

Related U.S. Application Data
(60) Provisional application No. 60/196,327, filed on Apr. 12, 2000.

(51) Int. Cl. H04N 5/232; G05B 23/02; H04N 7/18

(52) U.S. Cl. 348/42; 340/3.7; 348/148; 348/211; 446/454

(57) ABSTRACT

A portable personal wireless interactive video device including a miniature camera, a portable wireless transmitter connected to the camera, a portable wireless receiver for receiving video signals from the transmitter, and a portable video display device connected to the receiver for presenting an image to a viewer corresponding to a view from the perspective of the camera. The viewer may select an image for display on the video display device corresponding to a view from his/her own camera, from a camera worn by another person, or from one of several cameras positioned in selected locations. In one embodiment, the camera may be located within a remotely controlled model vehicle, thereby providing the viewer with a view from the perspective of inside the vehicle for viewing while remotely controlling the vehicle. Enhanced realism may be achieved by providing a true depth perception “stereo-optic” display by using two spaced apart cameras viewing the same scene and by presenting two corresponding independent channels of video information to the two eyes of the viewer. A “videotronics” capability allows the angle of view of the camera to be responsive to head movements of the viewer to further enhance the remote viewing experience.

The application claims the benefit of the Apr. 12, 2000, filing date of U.S. provisional patent application Ser. No. 60/196,327.

### FIELD OF THE INVENTION

The present invention relates generally to the field of personal wireless video entertainment, and more specifically to video images delivered through a portable personal wireless interactive video display system, and specifically to a hands-free personal video display device worn as a headset and adapted for displaying any one of a plurality of user-selectable displays representing corresponding views of a scene.

### BACKGROUND OF THE INVENTION

Remote control (RC) is a generally understood term referring to the control of a vehicle by an operator who is positioned at a location removed from the vehicle and who does not have physical contact with the vehicle. Remote control is used extensively for the control of vehicles and processes that involve environments that are dangerous or hazardous for the operator, such as military, law enforcement, nuclear and chemical applications. Remotely controlled toy vehicles are also well known as entertainment devices. Model RC airplanes, cars and boats have been popular for years and have provided countless hours of exciting and wholesome activity for entire families.

Toy RC vehicles have been adapted to simulate full size vehicles in many ways, such as by using exact scale model dimensions, special paint schemes, lighting, audio effects, etc. Because there is no physical contact between the operator and the vehicle, the operation of an RC toy is enjoyed from the perspective of an observer of the vehicle. There is no tactile stimulation created by the movements of the toy vehicle, and therefore, the sensations of speed and acceleration are missing from the experience. It is desirable to make the operation of a toy RC vehicle seem as realistic as possible to the operator. One technique for doing so is taught in U.S. Pat. No. 4,986,187 issued on Jan. 22, 1991, to Booth, et al., which describes a model train having a video device mounted thereon for providing a visual image corresponding to the scene in front of the vehicle. By viewing an electronic monitor, the operator of the model train can enjoy the view that would be seen from the operator's cab of the train. While such a change in perspective is different, the effect for the operator is no better than that obtained when watching a free-standing television.

It is also known that video display devices are limited in their realism because they present a two dimensional image. Many techniques have been applied to simulate a three dimensional image on a two dimensional video display. Most such techniques involve presenting two slightly different images produced by a single camera in a dithered display, with the observer wearing special optical lenses that allow the observer's right and left eyes preferentially to see one of the alternating images. A recent improvement in such systems is the use of two separate two-dimensional video displays for viewing by the observer's respective right and left eyes, with the dithered alternating images being supplied to the respective right and left video displays. One such system is the “i-glasses 3D” system available from I-O Display Systems of Sacramento, Calif. Such systems are commonly referred to as being stereoscopic, and while they provide some simulated sense of depth in the image, they lack true realism.

Many other forms of entertainment are enhanced by their visual content. For example, concerts and sporting events allow paying attendees to see their favorite artists or teams in a live performance. Because distance diminishes the level of detail that can be seen, it is known that the seats closest to the performance may be sold for a higher price than seats remote from the performance. In order to enhance the visual experience from the more remote seating areas, it is known to provide a very large screen video display at such entertainment events in order to provide the attendees with a better view of the performance. Camera operators at the performance record the action from a variety of perspectives and a director selects an image from among those cameras to be projected via the large screen video display. The same concept has been applied to entertainment broadcast on television. There have been many techniques used to provide a television audience with an enhanced view of a performance. These techniques include zoom lenses, cameras mounted on a goal post, and even cameras attached to referees and players participating in the event. The visual experience provided by such prior art techniques is limited because the view of the event is too small, the quality of the image may be distorted or partially blocked, or the view selected by a director is not necessarily a view desired by the particular observer.

It is also known to use radio devices to enhance the entertainment value of a car racing event. Car-to-crew radio communications may be received by fans at a car racing event, thus allowing the fans to hear voice communications during the race. While such devices provide the fans with additional information concerning the race, they fail to make the fans feel as though they are actually participating in the race because they provide only audible information.

### BRIEF SUMMARY OF THE INVENTION

Thus, there is a particular need for an improved device and method for providing entertainment. It is also desired to provide the attendees of an event with a better visual perspective of the scene of the event. It is further desired to improve the realism of the experience of operating a remotely controlled toy vehicle.

Accordingly, an apparatus for providing entertainment is disclosed herein as including: a plurality of cameras adapted for being located at a plurality of locations at an entertainment event for producing a plurality of video signals; a single channel or multi-channel wireless communications system for transmitting wireless communication signals corresponding to the plurality of video signals; and, a plurality of portable personal display units each containing a single channel or multi-channel receiving device and a portable video display device, the portable personal display units adapted for receiving the wireless communication signals and for displaying images responsive to selected ones of the video signals for personal viewing by on-site attendees of the entertainment event.

A remotely controlled toy vehicle is described herein as including: a model vehicle; a first wireless communication apparatus having a first transmitter remote from the model vehicle for sending control signals and having a first receiver attached to the model vehicle for receiving the control signals; a control apparatus attached to the model vehicle and operable to control the direction of travel of the model vehicle in response to the control signals; a video signal generating apparatus connected to the model vehicle and comprising a miniature camera(s) operable to generate video signals representative of a view from the perspective of the model vehicle; a wireless communication apparatus connected to the video signal generating apparatus and having a single channel or multi-channel transmitter attached to the model vehicle and operable to transmit the video signals to a portable single-channel or multi-channel receiver remote from the model vehicle; and a hands-free video display device connected to the receiver and operable to display an image corresponding to the view from the perspective of the model vehicle to a person wearing the hands-free video display device.

### BRIEF DESCRIPTION OF THE DRAWINGS

The features and advantages of the present invention will become apparent from the following detailed description of the invention when read with the accompanying drawings in which:

FIG. 1 illustrates two operators playing a racing game while wearing the portable operator portion of a personal wireless interactive video device that provides each operator with a view of the racetrack from the perspective of his/her respective racing vehicle.

FIG. 2 is a schematic illustration of portions of a prior art toy radio controlled racecar.

FIG. 3 is a perspective illustration of the vehicle portion of a stereo-optic video generation device attached to the toy radio controlled racecar of FIG. 2.

FIG. 4 is a perspective illustration of a personal video display device used in the racing game of FIG. 1.

FIG. 5 is a schematic illustration of a racing game utilizing personal video display devices wherein the communication of vehicle control signals and video signals is done via the Internet.

FIG. 6 is a block diagram of a portable personal wireless interactive video entertainment device that may be used to enhance the visual experience of attendees at an entertainment event.

FIG. 7 is a block diagram of a portable personal wireless interactive video device incorporating a base station display of video signals from a plurality of portable personal wireless interactive video devices.

FIG. 8 is a block diagram of a personal video device incorporating both video and audio transmission, reception and display.

### DETAILED DESCRIPTION OF THE INVENTION

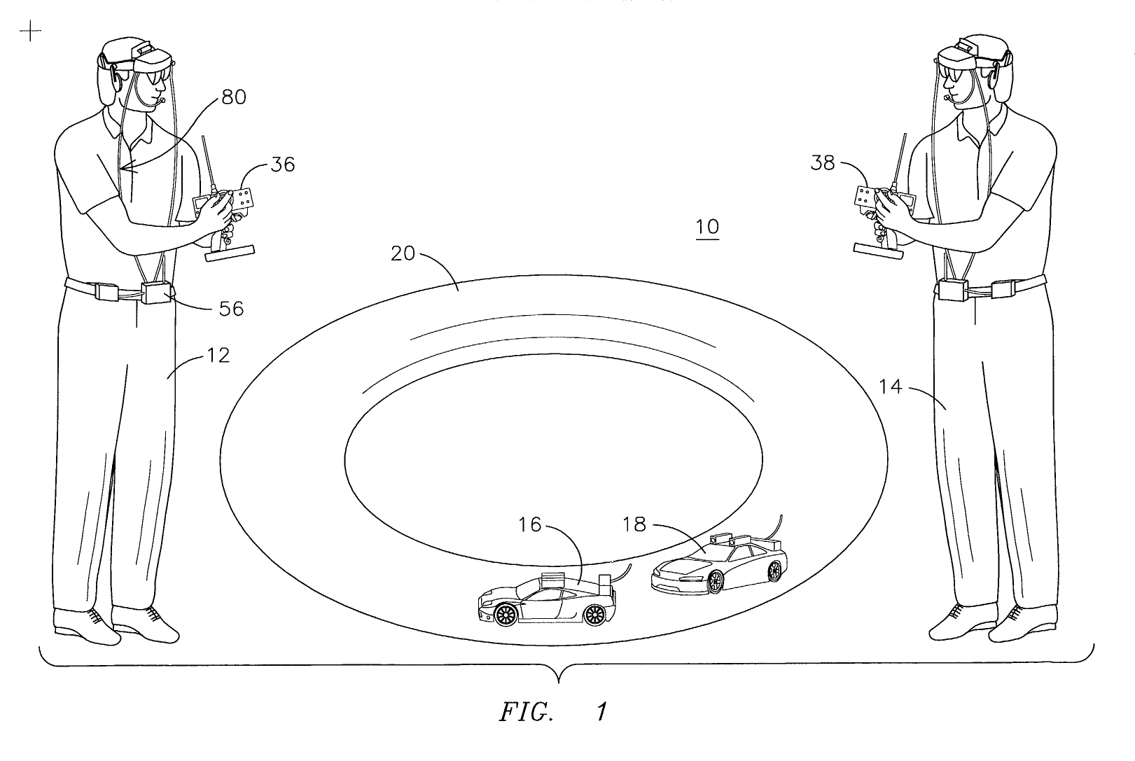

FIG. 1 is a perspective illustration of a portion of a racing game 10 being played by two operators 12, 14 controlling respective racing vehicles 16, 18 along a scale model track 20. In this embodiment, the scale model track 20 is designed to resemble an automobile racetrack, and the racing vehicles 16, 18 are remotely controlled (RC) toy scale model racecars. In other embodiments, the vehicles may be toy model boats, airplanes, trucks, military vehicles, dune buggies, etc. In some embodiments only a single RC vehicle may be used and may be operated over a natural surface that is not specifically adapted to be a toy vehicle racetrack. Toy vehicles may include slot cars or other vehicles that are controlled by speed control only, two-dimensional vehicles such as boats and cars wherein speed and two-dimensional steering are controlled, and three-dimensional vehicles such as airplanes and helicopters wherein speed and three-dimensional steering are controlled.

The racing vehicles 16, 18 may be self-propelled by internal combustion or electric motors and they may include steering and throttle controls as are well known in the art. FIG. 2 is a schematic illustration of a prior art toy model racecar 16 as may be used with the racing game 10 of FIG. 1. One such style of racecar is a “Chevy Avalanche Type 160021BC” sold by Nikko America, Inc. of Plano, Tex. The racing vehicle 16 includes a frame 22 supported on two drive wheels 24 and two steering wheels 26. An electric motor 28 is used to propel the vehicle 16 in both forward and reverse directions through drive wheels 26. Steering wheels 26 are directionally pivoted by the action of servo 30 to control the direction of movement of the vehicle 16. Both the servo 30 and the motor 28 are responsive to signals generated by receiver/controller 32. A rechargeable battery pack 38 provides electric power to motor 28, servo 30 and receiver/controller 32. Receiver/controller 32 is operable to receive wireless control signals from transmitter 36 through antenna 34. The transmitter is manipulated by operator 12, as seen in FIG. 1. Similarly, operator 14 manipulates transmitter 38 to control the movement of vehicle 18.

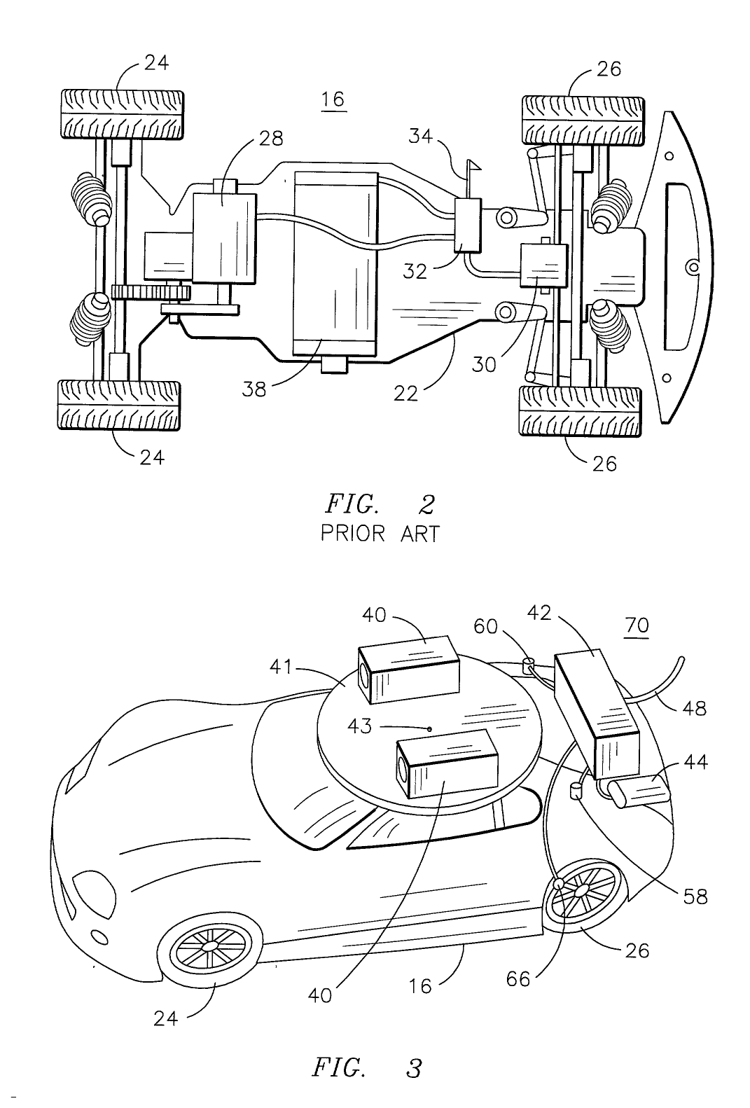

FIG. 3 is a perspective illustration of vehicle 16 illustrating additional audio-visual equipment that may be added to the prior art racing vehicle of FIG. 2 to provide improved realism for the operator 12 in racing game 10. One or more video cameras 40 are attached to racecar 16 to produce a view(s) from the perspective of the toy vehicle 16. In the embodiment of FIG. 3, a pair of cameras 40 are positioned to be forward looking on the racecar 16 to provide a stereo-optic view of the portion of the racetrack 20 directly in front of racecar 16. Cameras 40 may be placed in a fixed position, or may be mounted on a rotatable platform 41 or other positioning device for wireless remote controlled pivoting about an axis of rotation 43 or for providing other movement of the cameras 40 relative to the racecar 16, as will be discussed more fully below. Additional cameras (not shown) may be placed in or on the vehicle 16 to face in other directions, such as rearward facing to provide a view representing the rear-view mirror of the racecar 16. The term camera is used herein to refer to any known type of video signal generating apparatus. Other cameras may include infrared cameras, low light cameras, wide angle cameras, CCD optical devices, etc. Cameras 40 are operable to generate a video signal corresponding to the view in front of the cameras, and to provide the video signal to a wireless communication apparatus 42. Wireless communication apparatus 42, in turn, includes a single channel or multi-channel transmitter operable to transmit a wireless signal responsive to the video signal through antenna 48. One type of camera-transmitter-receiver system that may be used in this application is Model CV991C available from Nutex Communications Inc. of Hsincho, Taiwan, Republic of China. The standard directional antenna that is provided with the Model CV991C system is preferably replaced by an omni-directional matched frequency antenna, such as a 2.4 GHz quarter wave external antenna. The addition of such an omni-directional antenna has been found to significantly increase both quality performance and effective range of the portable personal interactive video system. One such system has been found to have an effective range of between 450 and 700 feet.

FIG. 4 is a perspective view of one embodiment of a portable personal interactive video device 80 worn by the operators 12, 14 while playing the racing game 10 of FIG. 1. A headset 50 contains video display devices 52, 54 positioned on the headset 50 at locations in front of the respective eyes of the person wearing the headset 50. One such headset 50 that may be used is the “i-glasses 3D” system available from I-O Display Systems of Sacramento, Calif. The term headset is used herein to include devices that are supported on, against or proximate a user's head so that a video display may be placed directly in front of the user's eye or eyes. In other embodiments, a hand-held video display device may be used. In still another embodiment, a retinal display device may be used.. A single channel or multi-channel wireless receiver 56 connected to headset 50 is operable to receive through antenna 57 the wireless signal transmitted by the wireless communication apparatus 42 attached to racecar 16. The wireless receiver 56 and a rechargeable battery power supply 55 for powering the receiver 56 and video display devices 52, 54 are attached to a belt, strap, garment, belt clip or other carrying device 59 that can be carried by the user 12, preferably without the use of his/her hands. In one embodiment, the receiver 56 and power supply 57 are sized to fit into a pocket of the clothing of the operator 12, thereby eliminating the need for a separate carrying device 59 while maintaining the portability of the operator's equipment. In another embodiment, all of the components of personal video device 80 are built to be integral with the headset 50, and may be designed in the style of a racing helmet, goggles, masks, monacles, glasses, visors or similar apparatus worn about the head of a user. The personal video device may use any sort of portable video display or displays, including a small flat screen monitor, hand-held video display, liquid crystal display, small portable television or other future technology that may be fully portable by the user for personal portable display of video information. The wireless video signal is converted by the receiver 56 to a video display signal, which is, in turn, used by video display devices 52, 54 to generate an image corresponding to the view from the perspective of the racecar 16. One may appreciate that by wearing the headset 50 and viewing the image presented by video display devices 52, 54 while operating transmitter 36, the operator 12 of racing game 10 will enjoy a more realistic racing experience because he/she will have the visual perspective of actually being inside the racecar 16. By using two cameras 40 and a two video display devices 52, 54, the operator 12 will enjoy a full three dimensional sensation including realistic depth perception. The term “stereo-optic” is used herein to describe a video system having two cameras positioned to view a scene from two slightly different perspectives corresponding to the two eyes of an observer, connected to two video display devices for producing two images corresponding to the views of the scene from the perspectives of the two cameras. An observer viewing the two video display devices with respective left and right eyes will enjoy true depth perception of the scene, as if actually being seen from the perspective of the location of the two cameras. Furthermore, the movement of racecar 16 around racetrack 20 is thereby viewed at full scale speed, further improving the realism of the visual experience. Other embodiments may utilize only one camera 40 for providing a single image without stereo-optic depth perception content. The lens selected for use with cameras 40 may be selected to generate a realistic view of the racetrack 20 when viewed through the stereo-optic headset 50, including seeing a portion of the racecar 16 within the field of view.

The term “videotronics” is used herein to describe how additional realism may be provided to operators 12, 14 by moving the cameras 40 in response to head movements of the operators. The headset 50 may include a head position sensing/tracking device 65, such as one or more accelerometers, for producing a position input signal in response to head movements. Other types of controllers may be used to produce the position input signal in response to a physical input provided by a user, for example a joystick type of device, a device for sensing the position of a user's eyes within the head, or a thumb pad on an RC transmitter. The position sensing device 65 is connected to a wireless transmitter for transmitting a wireless view signal responsive to the position input signal. The term wireless view signal is used herein to describe a wireless signal responsive to the view that the user desires to see. In one embodiment, wireless transmitter 56 may be used to transmit a wireless view signal multiplexed with or on a different frequency than the video signal. The wireless view signal may be received by a wireless receiver 42 which in turn produces a position signal responsive to the wireless view signal. A positioning device, such as rotatable platform 41, is adapted for moving the cameras 40 in response to the position signal in order to direct the cameras to view the surrounding scene in a direction desired by the user.

Additional realism may be provided to operators 12, 14 by including audio information as part of racing game 10. One or more microphones 58, 60 may be installed on racecar 16, as shown in FIG. 3, for providing an audio signal through wireless communication apparatus 42 and wireless receiver 56 to headphones 62, 64 as shown in FIG. 4. The audio system may also be used with microphone 66 attached to headset 50 to capture the voice of operators 12, 14, and by the addition of an additional audio transmitter to permit communication between the operators or other participants in the racing game 10.

Additional information may be provided to the operator 12 through headset 50 during the operation of racecar 16. For example, a speed sensor 66 may be added to vehicle 16 to sense the speed of rotation of drive wheel 26. The speed sensor output may be used by wireless communication apparatus 42 to insert a video overlay on a portion of the video image captured by cameras 40 to represent a speedometer of racecar 16. When viewing the image corresponding to the view from the perspective of the toy racecar 16, the operator will then be able to monitor the scale speed of the vehicle by glancing at an image of a speedometer located along a bottom portion of the image displayed by video display devices 52,54.

The racing game 10 may be provided as a full scope entertainment service to users who do not own any equipment. Alternatively, portions of the game may be provided to operators who own portions of the equipment. For example, a stereo-optic vision system may be provided in kit form for use by an operator who owns a prior art racecar 16 as shown in FIG. 2. Such a kit may include a vehicle portion 70 and an operator portion 80. The vehicle portion 70 may include the cameras 40, wireless communication apparatus 42 and interconnecting wiring and attachment hardware. The vehicle portion 70 may also include a battery pack 44 or an adapter for tapping into the power supply 38 of vehicle 16. The vehicle portion 70 may be sized and have attachment hardware adapted for installation onto a specific toy model vehicle, or it may include generic mounting hardware for attachment to a variety of toy racing vehicles. The operator portion 80 of such a kit may include the headset 50, receiver 56, battery pack 57 carrying device 59, and interconnecting wiring. The entire kit is small and portable and can be easily moved from one racing location to another. The vehicle portion 70 can be easily installed and removed, thereby making it possible to moved from one racing vehicle to another. The operator portion 80 advantageously provides hands-free operation by the user 12 during the operation of racing vehicle 16.

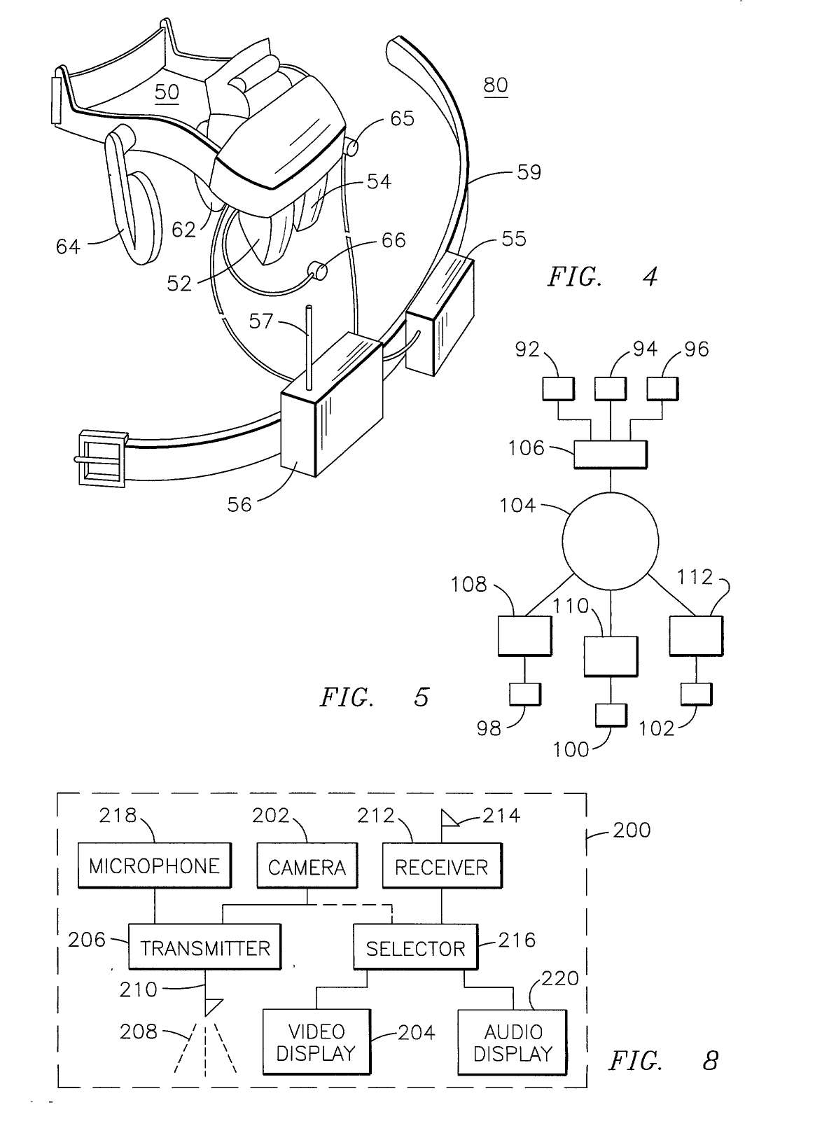

The racing game 10 may be used with tracked racing vehicles such as trains or slot cars without the need for wireless communication between the vehicle and the operator's headset 50. For such an embodiment, the video signal may be transmitted through the track itself, with a hard-wired connection being made between a receiver and the track. Such an embodiment may be useful when providing entertainment to operators who are located remote from the racing venue but who are connected to the racing game 10 via the Internet or other global communications device. FIG. 5 illustrates such an embodiment, where a plurality of model racing vehicles 92,94,96, similar to vehicles 16,18 described above, are controlled by a respective plurality of users located at remote locations using personal interactive video units 98, 100,102, similar to personal video devices 80 described above. Communication of the control signals and video signals is accomplished via an information network 104, such as the Internet, through respective communication links 106, 108, 110, 112, as are known in the art.

FIG. 6 illustrates a block diagram of another embodiment of the present invention. This embodiment may be useful at an event where it is desired to provide the attendees at the event with an improved visual experience. Such events may include entertainment, sports, recreational, training and education events, for example. FIG. 6 illustrates an entertainment system 120 including a plurality of cameras 122, 124, 126 disposed at various locations associated with the entertainment event. For example, when the entertainment system 120 is used within an arena for a musical concert event, the cameras 122, 124 may be directed toward various members of the band, while camera 126 may be affixed to a lead singer's hat to provide a view from the perspective of the lead singer. Each of the cameras, 122, 124, 126 is connected by hardwire or wireless links to a wireless transmitting device or devices 128, where the respective video signals 130, 132, 134 are converted to wireless signals 136 and transmitted throughout the arena via antennae 138. In one embodiment, each camera is connected to a separate transmitter for transmitting a signal on a unique frequency. One skilled in the art may appreciate that the frequency of operation of transmitter 128 may be selected to avoid interference with other wireless communication devices that may be utilized at the same venue. Wireless communication signal 136 may contain components responsive to each of the respective video signals 130, 132, 134, such as by carrying multiple channels or by other multiplexing techniques known in the field of wireless communications. A plurality of personal portable display units 140, 142 are used to receive the wireless communication signal 136 and to display an image for personal viewing by attendees at the event. Audio information may be included along with the video information. Receivers 144, 146 receive the wireless communication signal 136 through respective antennas 148, 150. A selector 152, 154 is connected between receiver 144, 146 and respective video display devices 156, 158 in order to allow the attendee/wearer of the display unit to display an image responsive to selected ones of the video signals 130, 132, 134 for personal viewing by that attendee. The selector 152, 154 may be a simple electromechanical switch for toggling between channels, or it may be an electronic switch including software and/or firmware elements. In one embodiment, the personal display units 140, 142 are constructed to be headsets that are fully integrated to contain all of the necessary equipment and power supplies for performing the functions described above.

It may be appreciated that the personal display units 140, 142 of FIG. 6 may be useful for enhancing the experience obtained by an attendee at an event. Because the display units 156, 158 may be located very close to the eyes of the viewer, the viewer will be provided with a visual experience that is very close-up and personal and accordingly is expected to be more entertaining than the visual experience achieved through the naked eye or through a large screen arena display. Display units 140, 142 may provide true depth perception via a stereo-optic image to further enhance the visual experience. Because the user has the personal ability to select the desired channel of video information to be displayed on display devices 156, 158, each individual attendee may experience a visual perspective that is personally selected to be most pleasing to that particular attendee/viewer.

The portable personal wireless interactive video device 120 provides the operator of an entertainment facility with additional opportunities for revenue generation. It is known that the improved visual experience of close-in seats will generate a higher revenue than will the remote viewing experience of seats located far away from the location of the entertainment. Accordingly, it is anticipated that attendees at an entertainment event may be willing to pay for the use of portable personal wireless interactive video display units 140, 142 on a rental basis in order to enhance their viewing experience. Furthermore, the operator of the video entertainment system 120 may also be able to generate revenue by selling advertising time to various product sponsors for delivery via system 120. It is known that cleverly produced and entertaining advertisements are well received by a viewing audience, as exemplified by the highly touted television advertisements broadcast during a National Football League Super Bowl event. It is expected that such clever advertisements may be voluntarily viewed by the attendees at an entertainment event when displayed on portable personal wireless interactive video display units 140, 142 during breaks in the entertainment, such as during timeouts of a basketball game. In addition to voluntary viewing, the user of the portable personal display units 140, 142 may be enticed to watch advertising content delivered in conjunction with supplementary entertainment content. For example, various product or service promotions may be announced by transmitting wireless communication signal 136 including such promotions for display on the display units 156, 158. Such content may be transmitted on a separate channel of wireless signal 136 together with other video signals 130, 132, 134, or alternatively, may replace the video signals 130, 132, 134 during breaks in the entertainment activity, such as intermission in a show or timeouts of a ball game. One may appreciate that other types of predetermined information content may be provided to the attendees, for example, by having a separate instant replay channel, by having a channel dedicated to statistics or other historical information related to the entertainment event, or by providing an adult-only channel having information content that is not appropriate for young viewers. In one embodiment, portable personal wireless interactive video display unit 140 may be programmed to be able to select only content appropriate for young viewers, while another personal display unit 142 may be programmed to receive all channels of communication contained in wireless signal 136. Similarly, the rent charged for the use of a particular personal display unit 140, 142 may be varied to correspond to the content which can be viewed by that particular display unit.

For an educational/training event, a camera 122 may be worn by an instructor, such as a surgeon demonstrating a surgical operation. A plurality of students may each view a personal video display device 140,142 from a position close to or remote from the instructor, such as in arena seating above an operating room. Other camera 124, 126 may be positioned to view other scenes associated with the operation, such as an instrument reading, the view seen by an anesthesiologist, the view seen via a fiber optic probe being used during the operation, etc. The students may select the image of most interest to them, or may be directed to select a specific image by the instructor.

A portable personal wireless interactive video display unit such as 140, 142 of FIG. 6, may be store-bought and owned by an individual and, thereby, may be used in many applications incorporating such technology. For example, personal wireless display units sold under the trademark “VENUALITY” by the assignee of the present invention are envisioned to be operable for a plurality of applications, such as in a racing game as illustrated in FIG. 1, as well as at an entertainment event such as is illustrated in FIG. 6. By making such technology available at an entertainment event, a promoter may be able to promote the event as a VENUALITY INSIDE event and to charge a price premium for a ticket that allows an attendee to bring along his/her own VENUALITY personal display device. Alternatively, the attendee may rent such a device at the entertainment location, as discussed above.

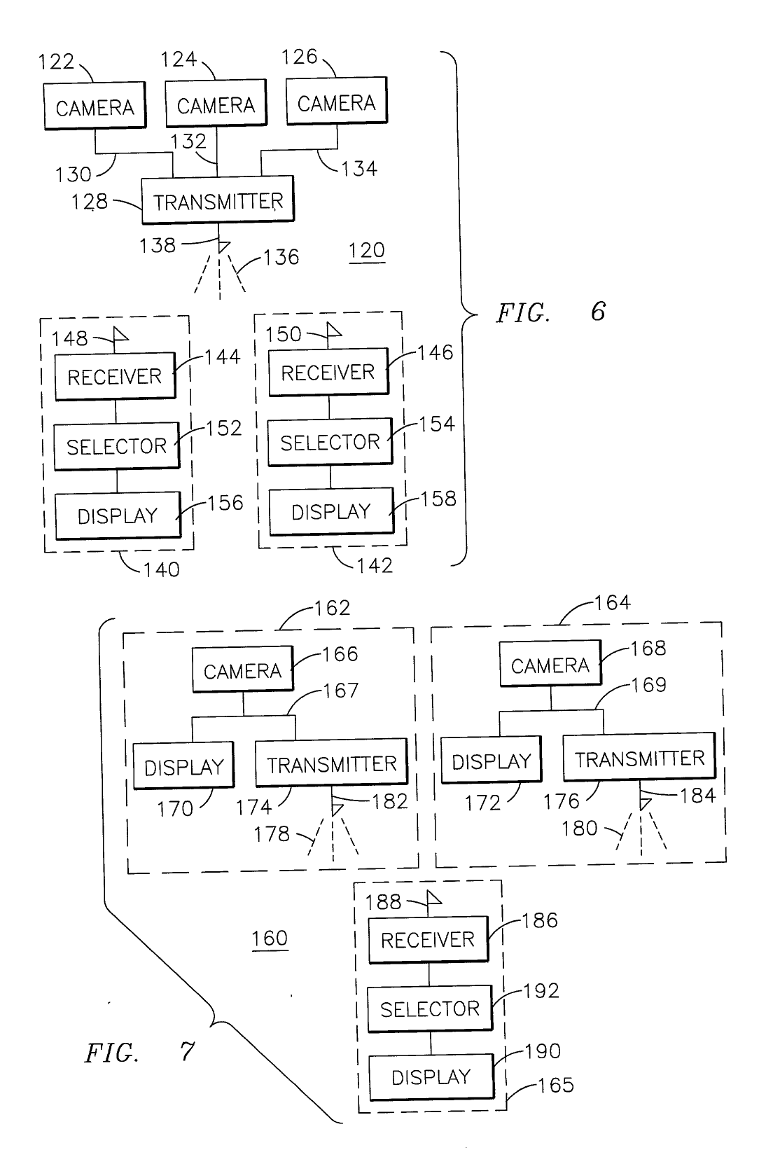

FIG. 7 is a block diagram of a further embodiment of the present invention. A video communications system 160 includes a plurality of portable personal wireless interactive video units 162, 164 and a base station video display unit 165. In this embodiment, each personal video unit 162, 164 includes a camera 166, 168 for producing video signals 167, 169, a display unit 170, 172 for displaying an image responsive to the video signals 167, 169, and a transmitter 174, 176 for transmitting a wireless communication signal 178, 180 corresponding to the video signals through antennas 182, 184. One may appreciate that wireless communication signals 178, 180 are preferably transmitted at different frequencies from each other. The base station 166 includes a receiver 186 for receiving the wireless communication signals 178, 180 through antenna 188, and a display unit 190 for selectively displaying the image captured by cameras 166, 168 as selectively controlled by personal selector 192. One may appreciate that the display unit 190 may be capable of displaying only a single video image or a plurality of video images concurrently. The portable personal wireless interactive video device 160 may be useful for team sport competitions or other team activities where a plurality of participants are provided with portable personal wireless video units 162, 164 for allowing other team members, non-participants, advisors or judges to view video images corresponding to the view of any one or more of the respective participant as selected. Advantageously, each portable personal wireless interactive video unit 162, 164 may be embodied as an individual headset providing not only a housing for the various electronic components described above, but also providing impact protection for the head of the participant. One such embodiment may be a team paint-ball or laser-tag competition where team coordinators or judges are located at one or more such base stations 165.

It may be appreciated that the cameras 166, 168 of FIG. 7 as well as the cameras of the other embodiments described herein, may be standard visual light color cameras, low light black and white cameras, infrared cameras, or other specialty cameras that may be known in the art. For the application of FIG. 7, it may be useful to utilize a low light or infrared camera for an activity that occurs at night or in a low light, smoky, or foggy environment, such as a nighttime paint ball competition. By providing such cameras, the visual capability of the respective participants may be enhanced by providing them with a visual display 170, 172 that is responsive to low light or infrared or other forms of non-visible energy. Display units 170, 172 may be manufactured to have a flip-up feature allowing the user to view either the video display 170, 172 or an unobstructed natural view. In another embodiment, cameras 166, 168 and their respective transmitters 174, 176 may be made detachable from the personal video unit 162, 164 so that the user may position the camera/transmitter away from the headset unit for viewing alternative locations, such as for viewing around a corner, or for viewing a fixed location while the user moves away from such location. In this embodiment, the camera 166, 168 and display 170, 172 would be linked with an appropriate wireless communications link. In other embodiment, cameras 166, 168 may be rotated to point in various directions relative to the personal video unit 162, 164 to allow the user to provide video information to the base station 166 or to other team members in either a forward looking, reverse looking, or other desired viewing angle.

FIG. 8 illustrates a block diagram of another embodiment of a personal video device 200. Similar to personal video unit 162, the device 200 includes a camera 202, a video display unit 204, and a transmitter 206 for transmitting a wireless communication signal 208 via antennae 210. In addition, device 200 includes a receiver 212 adapted to receive a plurality of wireless signals through antennae 214 and a selector 216 for selectively displaying images representative of either the view of camera 202 or the view of other similar personal video units that are received by receiver 212. The connection between the selector 216 and the camera 202 is indicated by a dashed line to represent that such connection may be by hard wiring or via a wireless link through transmitter 206 and receiver 212. In addition, device 200 includes a microphone 218 connected to transmitter 206 for including audio information in wireless communication signal 208. Similarly receiver 212 may be adapted to receive audio information associated with various video signals being received and for displaying such audio information via an audio display 220, such as a speaker or earphone. Selector 216 allows the wearer to select for display any one of a plurality of video/audio displays associated with the view from the perspective of any of a plurality of wearers of similar devices 200, including his/her own personal view as augmented by camera 202. Thus, individually and together the camera 202 and the receiver 212 constitute input devices operable to provide signals corresponding to various views. One may appreciate that such portable personal wireless interactive video units 200 may be worn by a plurality of users for enhancing a video experience such as a sport or a team effort. In one embodiment, each of the members of a team wears a personal video unit 200 embodied as an integrated protective headset to enable the user to view either an augmented visual display provided by his/her own camera 202 or an image produced by the camera 202 of a fellow team member as may be selected via selector 216. In this manner, each team member may selectively view the area surrounding other team members, and with the addition of audio capability 218, 220, may communicate verbally with other team members.

The system described herein may be configured with one or more cameras/transmitters for use with a single receiver/display device. For example, a hobbyist may purchase a single camera/transmitter unit for use with multiple model vehicles, or may purchase multiple camera/transmitter units for use in multiple model vehicles with a single receiver/display device. By providing multi-channel capability on distinct frequencies, multiple hobbyists may operate similar units at the same time in order to compete against one another. Similarly, multiple camera/transmitter units each transmitting at a unique frequency may be positioned to view various scenes at an event, such as one unit in each of several go-carts, full-sized race cars, 4×4 monster trucks, etc. A plurality of spectators may then view the event from a selected perspective by selecting the particular frequency corresponding to the desired camera, such as viewing a go-cart race from the perspective of a favorite go-cart driver. In this manner, multiple spectators may be watching from any given perspective, and each spectator may select a different perspective at any time during the event. By maintaining the camera/transmitting devices and the receiver/display devices on predetermined frequencies with predetermined signal protocols, such devices may be used in many different applications at different times. For example, the owner of a VENUALITY brand receiver/display may use such device with his/her own VENUALITY brand camera/transmitter mounted on a remote controlled model for operating the model vehicle, then later may take the personally worn receiver/display portion of such device to a musical concert featuring a VENUALITY INSIDE service for enhanced viewing of the concert.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

We claim as our invention:

1. A remotely controlled toy vehicle comprising:
a model vehicle;
a first wireless communication apparatus having a first transmitter remote from the model vehicle for sending control signals and having a first receiver attached to the model vehicle for receiving the control signals;
a control apparatus attached to the model vehicle and operable to control the direction of travel of the model vehicle in response to the control signals;
a video signal generating apparatus connected to the model vehicle and comprising a camera operable to generate video signals representative of a view from the perspective of the model vehicle;
a second wireless communication apparatus connected to the video signal generating apparatus and having a second transmitter attached to the model vehicle and operable to transmit the video signals to a second receiver remote from the model vehicle;
a portable video display device connected to the second receiver and operable to display an image corresponding to the view from the perspective of the model vehicle.

2. The toy vehicle of claim 1, further comprising:
a sensor for producing a position signal responsive to a physical input provided by a viewer of the portable video display device;
wherein the video signal generating apparatus further comprises a positioning device adapted for moving the camera within the model vehicle in response to the position signal.

3. A kit for use with a remotely controlled toy vehicle, the kit comprising:
a vehicle portion adapted for attachment to the toy vehicle, the vehicle portion comprising a camera and a transmitter connected to the camera and operable to transmit wireless signals responsive to a view from the perspective of the toy vehicle;
an operator portion adapted for hands free viewing by an operator of the toy vehicle, the operator portion comprising a receiver and a video display device and operable to receive the wireless signals and to generate an image corresponding to the view from the perspective of the toy vehicle.

4. The kit of claim 3, wherein the vehicle portion comprises two cameras and the operator portion comprises two video display devices for generating a stereo-optic image corresponding to the three dimensional view from the perspective of the toy vehicle.

5. A racing game comprising:
a scale model track;
a plurality of racing vehicles adapted to operate on the scale model track;
a plurality of remote controllers, each remote controller adapted to transmit a control signal to a respective one of the racing vehicles to control the movement of that racing vehicle in response to actions of a user;
a video camera apparatus attached to each of the plurality of racing vehicles, each video camera apparatus operable to transmit a video signal responsive to a stereo-optic view of the scale model track from the perspective of the respective racing vehicle;
a plurality of video headsets, each headset adapted to receive the video signal from a respective video camera apparatus and to display a stereo-optic image representative of the view of the scale model track from the perspective of the respective racing vehicle for viewing by the user while operating the respective remote vehicle.

6. The racing game of claim 5, further comprising an Internet communication apparatus for transmitting the control signals and video signals via the Internet to enable the plurality of remote controllers and plurality of video headsets to be used from a plurality of locations remote from a location of the scale model track.

7. A method of providing entertainment to attendees at an event, the method comprising:
providing a plurality of cameras at a plurality of locations at the event for producing a plurality of video signals;
transmitting wireless communication signals corresponding to the plurality of video signals via a transmitter at the event; and
providing a plurality of portable display units each containing a receiving device and a video display device, the portable display units adapted for receiving the wireless communication signals directly from the transmitter and for displaying images responsive to selected ones of the video signals for personal viewing by attendees at the event.

8. The method of claim 7, further comprising:
providing a pair of cameras at each of the plurality of locations at the event for producing a plurality of stereo-optic video signals;
transmitting wireless communications signals corresponding to the plurality of stereo-optic video signals via the wireless communications system; and
providing the personal display units with stereo-optic video display devices for displaying three dimensional images for personal viewing by the attendees.

9. The method of claim 7, further comprising offering the personal display units for rent to the attendees for use during the event.

10. The method of claim 7, further comprising transmitting wireless communications signals corresponding to predetermined content via the wireless communications system for selected viewing by the attendees.

11. The method of claim 7, further comprising transmitting wireless communications signals corresponding to advertising content via the wireless communications system for viewing by the attendees.

12. An apparatus for providing video information comprising:
at least one camera adapted for capturing at least one scene at an event and for producing at least one respective video signal responsive to the at least one scene;
a transmitter for transmitting at least one wireless communication signal corresponding to the at least one video signal;
a plurality of portable display units each containing a receiving device and a video display device for receiving the at least one wireless communication signal directly from the transmitter and for displaying images responsive to the at least one wireless communication signal for personal viewing of the at least one scene by attendees at the event.

13. The apparatus of claim 12, wherein each personal display unit comprises a headset for supporting the receiving device and the video display device.

14. A video device comprising:
a headset;
a video display device attached to the headset and operable to display a video image responsive to an input signal;
an input device attached to the headset and operable to provide a plurality of signals corresponding to a plurality of scenes; and
a selector attached to the headset for selectively providing ones of the plurality of signals to the video display device as the input signal for display of a corresponding video image to a user of the headset.

15. The device of claim 14, wherein the input device comprises a wireless receiver adapted to receive a wireless signal responsive to a plurality of video signals.

16. The device of claim 15, wherein the input device further comprises a camera adapted for attachment to the headset.

17. A video communications apparatus comprising:
a camera adapted for hands-free portability by a user, the camera operable to produce a video signal;
a display unit adapted for hands-free portability by the user and connected to the camera for displaying an image corresponding to the video signal for viewing by the user; and
a transmitting device adapted for hands-free portability by the user and connected to the camera for transmitting a wireless communication signal responsive to the video signal.

18. The apparatus of claim 17, wherein the camera is an infrared camera and the video signal and image are responsive to infrared radiation.

19. The apparatus of claim 17, further comprising a base unit, the base unit further comprising a receiver for receiving the wireless communication signal and a display device for displaying an image responsive to the wireless communication signal.

20. A wireless video apparatus comprising:
a plurality of portable personal video units, each unit comprising a camera for producing a video signal and a display unit for displaying an image responsive to the video signal and a transmitter for transmitting a wireless communication signal responsive to the video signal;
a receiver associated with each portable personal video unit adapted for receiving the wireless communication signals transmitted from other respective portable personal video units; and
a selector associated with each portable personal video unit and connected to the respective receiver and display unit for selecting an image for display on the display unit corresponding to a selected one of the video signals produced by others of the portable personal video units.

21. The apparatus of claim 20, further comprising a base unit comprising:
a receiver for receiving the wireless communication signals transmitted by each of the plurality of portable personal video units; and
a display device for displaying images responsive to selected ones of the wireless communication signals.

22. The apparatus of claim 20, wherein the camera is an infrared camera and the video signal and image are responsive to infrared radiation.

23. An entertainment device comprising:
a plurality of vehicles responsive to control signals;
a plurality of controllers operable by a user to produce control signals for controlling respective ones of the plurality of vehicles;
a video transmitting device attached to each of the plurality of vehicles and operable to produce a video signal responsive to a view from a perspective of the respective vehicle;
a plurality of portable video display devices adapted to receive video signals from respective ones of the video transmitting devices and to display respective images for personal viewing by the respective user operating the control device for the respective vehicle; and
an information network for communicating the control signals and the video signals to allow the users to control the respective vehicles from locations remote from the vehicles and remote from other users while viewing an image from the perspective of the respective vehicle being controlled.

24. A wireless video apparatus comprising:
a pair of video cameras adapted to be positioned adjacent each other to capture a stereo-optic view of an scene;
a transmitting device connected to each video camera for transmitting a wireless video signal responsive to the view from the perspective of the respective video camera;
a portable receiver for receiving the wireless video signals;
a pair of portable video display devices for cooperatively displaying to an observer a stereo-optic image responsive to the wireless video signals and observable as a three dimensional view of the scene from the perspective of the pair of video cameras.

25. The wireless video apparatus of claim 24, further comprising:
a plurality of pairs of cameras adapted to be positioned to receive respective stereo-optic views of a plurality of scenes;
a transmitting device connected to each video camera for transmitting a respective wireless video signal responsive to the view from the perspective of the video camera;
a selector associated with the portable receiver for selectively displaying to the observer a stereo-optic image from the perspective of a selected pair of cameras.

26. The personal wireless video apparatus of claim 24, further comprising:
a positioning device attached to the pair of cameras for moving the pair of cameras relative to the scene in response to a position signal;
a wireless receiver connected to the positioning device and adapted to provide the position signal in response to a wireless view signal;
a portable wireless transmitter for transmitting the wireless view signal in response to a position input signal;
a portable controller connected to the portable wireless transmitter for producing the position input signal in response to a physical input provided by the observer.

27. A method of providing video information, the method comprising:
providing a plurality of cameras at a plurality of locations for producing a plurality of video signals;
transmitting wireless communication signals corresponding to the plurality of video signals via a wireless communications system; and
providing a portable display unit containing a receiving device and a video display device, the portable display unit adapted for directly and locally receiving the wireless communication signals and for displaying images responsive to selected ones of the video signals for personal viewing by a user of the portable display unit.

28. The method of claim 27, further comprising:
providing a pair of cameras at each of the plurality of locations for producing a plurality of stereo-optic video signals;
transmitting wireless communications signals corresponding to the plurality of stereo-optic video signals via the wireless communications system; and
providing the personal display unit with stereo-optic video display devices for displaying three dimensional images for personal viewing by the user.

29. A wireless video apparatus comprising:
a video camera adapted to be positioned to capture a view of a scene;
a transmitting device connected to the video camera for transmitting a wireless video signal responsive to the view from the perspective of the video camera;
a portable receiver for receiving the wireless video signal directly from the transmitting device; and
a portable video display device for displaying to an observer an image responsive to the wireless video signal and corresponding to a view of the scene from the perspective of the camera.

30. The wireless video apparatus of claim 29, further comprising:
a plurality of cameras adapted to be positioned to receive respective views of a plurality of scenes;
a transmitting device connected to each video camera for transmitting a respective wireless video signal responsive to the view from the perspective of the video camera;
a selector associated with the portable receiver for selectively displaying to the observer an image from the perspective of a selected camera.

31. The personal wireless video apparatus of claim 29, further comprising:
a positioning device attached to the camera for moving the camera relative to the scene in response to a position signal;
a wireless receiver connected to the positioning device and adapted to provide the position signal in response to a wireless view signal;
a portable wireless transmitter for transmitting the wireless view signal in response to a position input signal;
a portable controller connected to the portable wireless transmitter for producing the position input signal in response to a physical input provided by the observer.

32. The wireless video apparatus of claim 29, further comprising:
the video camera comprising a pair of spaced apart video cameras disposed to capture respective views of the same scene;
the portable video display device comprising a pair of spaced apart video display devices adapted for displaying to the observer a three dimensional view of the scene from the perspective of the pair of spaced apart video cameras.
